(19) United States
(12) Patent Application Publication
(10) Pub. No.: US 2018/0313441 A1
(43) Pub. Date: Nov. 1, 2018

(54) TORQUE CONVERTER FOR VEHICLE INCLUDING VIBRATION REDUCTION APPARATUS USING PENDULUM

(71) Applicant: KOREA POWERTRAIN CO., LTD., Daegu (KR)

(72) Inventors: Seong Young SONG, Daegu (KR); Wan CHOI, Daegu (KR); Gook Sun LEE, Daegu (KR); Soon Cheol SHIN, Daegu (KR)

(21) Appl. No.: 15/739,578

(22) PCT Filed: Jun. 15, 2016
(86) PCT No.: PCT/KR2016/007720

§ 371 Date: Dec. 22, 2017

(30) Foreign Application Priority Data
Jul. 16, 2015 (KR) 10-2015-0100911

(51) Int. Cl. F16H 45/02; F16F 15/123; F16F 15/14

(52) U.S. Cl. CPC F16H 45/02; F16F 15/12366; F16H 2045/0231; F16H 2045/0226; F16H 2045/0263; F16F 15/145

(57) ABSTRACT

Provided is a torque converter for a vehicle including a vibration reduction apparatus included in the torque converter for a vehicle to attenuate vibration and impact in a rotation direction of the torque converter. Particularly, provided is a torque converter for a vehicle to which a vibration reduction apparatus using a pendulum is coupled by having the pendulum disposed on a hub included between a turbine and a transmission to thereby improve damping efficiency.

### TECHNICAL FIELD

The present invention relates to a torque converter for a vehicle including a vibration reduction apparatus included in the torque converter for a vehicle to attenuate vibration and impact in a rotation direction of the torque converter, and more particularly, to a torque converter for a vehicle including a vibration reduction apparatus using a pendulum capable of improving damping efficiency by including the pendulum in a hub included between a turbine and a transmission.

### BACKGROUND ART

In general, a torque converter is installed between an engine and a transmission of a vehicle to transfer driving power of the engine to the transmission using a fluid. Such torque converter includes an impeller receiving the driving power of the engine to be rotated, a turbine rotated by oil discharged from the impeller, and a reactor (also called ‘stator’) allowing a flow of the oil backwardly flowing into the impeller to flow in a rotation direction of the impeller to thereby increase torque variation.

Since power transfer efficiency of the torque converter may be decreased when a load acting on the engine is increased, the torque converter includes a lock up clutch (or also called ‘damper clutch’) capable of directly connecting between the engine and the transmission. The lock up clutch is disposed between a front cover directly connected to the engine and the turbine to allow rotational power of the engine to be directly transferred to the transmission through the turbine.

Such lock up clutch includes a piston which is movable in a shaft direction with respect of a turbine shaft. In addition, a torsional damper is provided which may absorb impact and vibration acting in a rotation direction when the lock up clutch is operated.

FIG. 1, which is a half cross-sectional view of a torque converter for a vehicle according to the related art taken along a shaft direction thereof, shows the torque converter for a vehicle.

The torque converter according to the related art includes a front cover 1 connected to a crank shaft of an engine to be rotated, an impeller 2 connected to the front cover 1 to be rotated together with the front cover 1, a turbine 3 disposed at a position facing the impeller 2, and a reactor 4 (or called ‘stator’) positioned between the impeller 2 and the turbine 3 and changing a flow of oil discharged from the turbine 3 to be transferred to the impeller 2. The reactor 4 transferring the oil to the impeller 2 has the same rotation center as the front cover 1. In addition, the torque converter provides a lock up clutch 5 as a means for directly connecting the engine and a transmission to each other. The lock up clutch 5 is disposed between the front cover 1 and the turbine 3.

The lock up clutch 5 is formed in approximately a circular plate, and includes a piston 6 which is movable in a shaft direction.

In addition, a torsional damper 7 is coupled to the lock up clutch 5. The torsional damper 7 serves to transfer driving power transferred through the lock up clutch 5 to the turbine 3 and to absorb torsional force acting in a rotation direction of a shaft and to attenuate vibration.

The lock up clutch 5 described above includes a friction plate 8 disposed between the front cover 1 and the piston 6. The friction plate 8 includes friction materials 8a coupled to both sides thereof. Therefore, when the piston 6 of the lock up clutch 5 is moved in a direction toward the front cover 1 by oil pressure, the driving power transferred to the front cover 1 may be transferred to the friction plate 8 while the friction materials 8a closely adhere to the front cover 1 and the piston 6.

Since the torque converter according to the related art described above operates the lock up clutch in a high speed revolutions per minute (RPM) region, which a predetermined RPM or more of the engine, due to the fact that vibration is serious when the lock up clutch is operated in a low speed RPM region of the engine, there is a problem that fuel efficiency of a vehicle is significantly decreased. Therefore, a technology has recently been known that a vibration reduction apparatus using a pendulum is applied to the torsional damper 7 so that vibration and impact in the rotation direction may be sufficiently attenuated even in the low speed RPM region.

FIG. 2 shows a schematic view of a cross section of a torque converter 1000 to which a vibration reduction apparatus 600 according to the related art is applied.

As shown in FIG. 2, a torsional damper 400 includes a first torsional damper 410 disposed between a lock up clutch 120 and a turbine 350, and a second torsional damper 420 disposed between a turbine 350 and a hub 500. In this case, the vibration reduction apparatus 600 is coupled to an intermediate member 300 positioned between the first torsional damper 410 and the second torsional damper 420, and pendulums which are moved in a radial direction by centrifugal force are disposed, such that the pendulums serves as a mass body, thereby making it possible to absorb vibration and impact in a rotation direction.

The torque converter 1000 to which the above-mentioned vibration reduction apparatus 600 is applied has an advantage that it may reduce vibration and the impact of the torsional damper 400 through a motion of the pendulum. However, as needs for reducing the vibration and the impact of the vehicle are recently further enhanced to improve sensitive quality of a passenger of the vehicle, a development of a torque converter having excellent vibration and impact reduction efficiency as compared to the torque converter to which the vibration reduction apparatus according to the related art is applied is required.

### RELATED ART DOCUMENT

### Patent Document

Korean Patent No. 10-1358998 (registered on Feb. 7, 2014)

### DISCLOSURE

### Technical Problem

An object of the present invention is to provide a torque converter for a vehicle including a vibration reduction apparatus using a pendulum, in which the vibration reduction apparatus absorbing vibration and impact using the pendulum of which a position is varied depending on centrifugal force is applied to the torque converter, and the vibration reduction apparatus is disposed at a hub connecting a turbine and a transmission to each other, that is, a rear end of a second torsional damper to thereby increase vibration and impact reduction efficiency.

### Technical Solution

In one general aspect, a torque converter for a vehicle including a vibration reduction apparatus using a pendulum includes: a main member includes a front cover, an impeller coupled to the front cover to be rotated together with the front cover; an intermediate member disposed at a position facing the main member; a reactor positioned between the main member and the intermediate member and changing a flow of oil discharged from the intermediate member to the main member side; a torsional damper coupled to the main member or the intermediate member and absorbing vibration and impact in a rotation direction; a hub connected to the torsional damper to transfer driving power to the transmission, wherein the vibration reduction apparatus is coupled to one side of the hub, and the vibration reduction apparatus includes a support plate; a plurality of pendulums disposed at one side or both sides of the support plate; and a plurality of coupling pins coupling the pendulums to the support plate while varying positions of the pendulums depending on centrifugal force.

The torsional damper may include a first torsional damper included between the main member and the intermediate member, and a second torsional damper included between the intermediate member and the hub.

The first torsional damper may have each of a main element and a sub-element, and the second torsional damper may have each of a main element and a sub-element, and the main element of the first torsional damper may be the main member, the sub-element thereof may be the intermediate member, the main element of the second torsional damper may be the intermediate member, and the sub-element thereof may be the hub.

The torque converter may include a turbine disposed at a position facing the impeller, and the turbine may be positioned at any one selected from the main element of the first torsional damper, the sub-element of the first torsional damper, the main element of the second torsional damper, and the sub-element of the second torsional damper.

The main element of the second torsional damper and the sub-element of the first torsional damper may be connected to each other to be non-rotatable with respect to each other.

The vibration reduction apparatus may be disposed on the sub-element of the second torsional damper.

### Advantageous Effects

The torque converter for a vehicle including a vibration reduction apparatus using a pendulum according to the present invention having the above-mentioned configuration significantly reduces vibration and impact in the rotation direction in the case in which the vibration reduction apparatus is coupled to the hub as compared to the case in which the vibration reduction apparatus is coupled to the intermediate member as in the related art, thereby making it possible to improve fuel efficiency of the vehicle.

### DESCRIPTION OF DRAWINGS

FIG. 1 is a cross-sectional view taken along a shaft direction of a general torque converter.

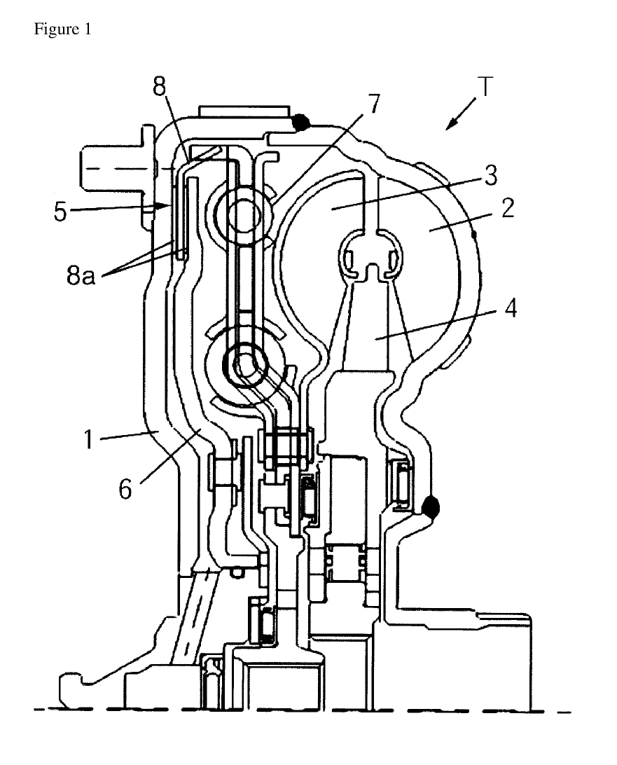

FIG. 2 is a schematic cross-sectional view of a torque converter including a vibration reduction apparatus according to the related art.

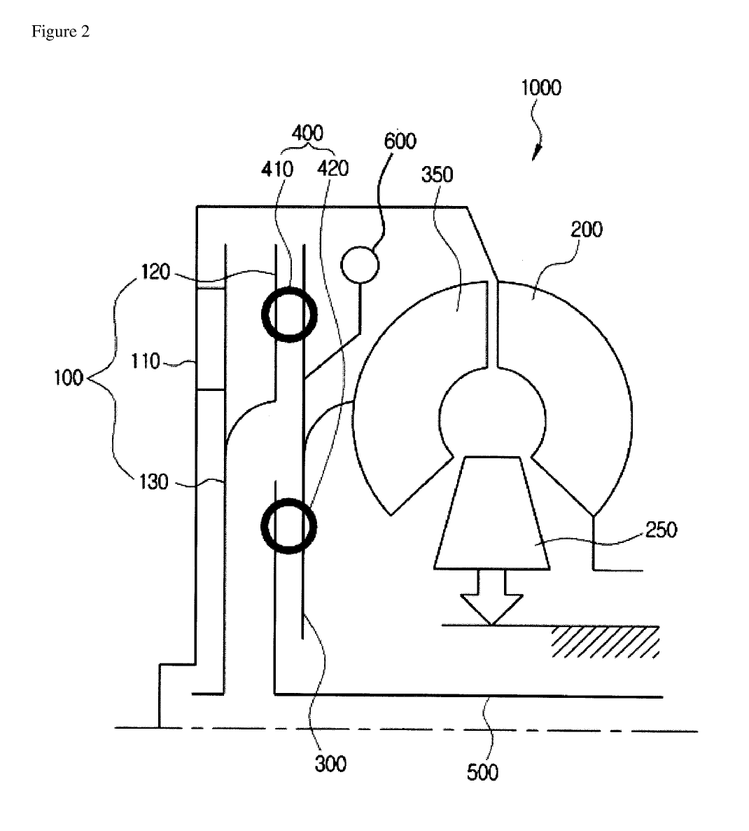

FIG. 3 is a schematic cross-sectional view of a torsional damper according to a first exemplary embodiment of the present invention (a twin damper type).

FIG. 4 is a power transfer view of the torsional damper according to the first exemplary embodiment of the present invention (a twin damper type).

FIG. 5 is a schematic cross-sectional view of a torsional damper according to a second exemplary embodiment of the present invention (a series damper type).

FIG. 6 is a schematic cross-sectional view of a torsional damper according to a third exemplary embodiment of the present invention (a turbine damper type).

FIG. 7 is an exploded perspective view of a vibration reduction apparatus according to the present invention.

### BEST MODE

Hereinafter, an exemplary embodiment of the present invention will be described in detail with reference to the accompanying drawings.

### First Embodiment (Twin Damper Type)

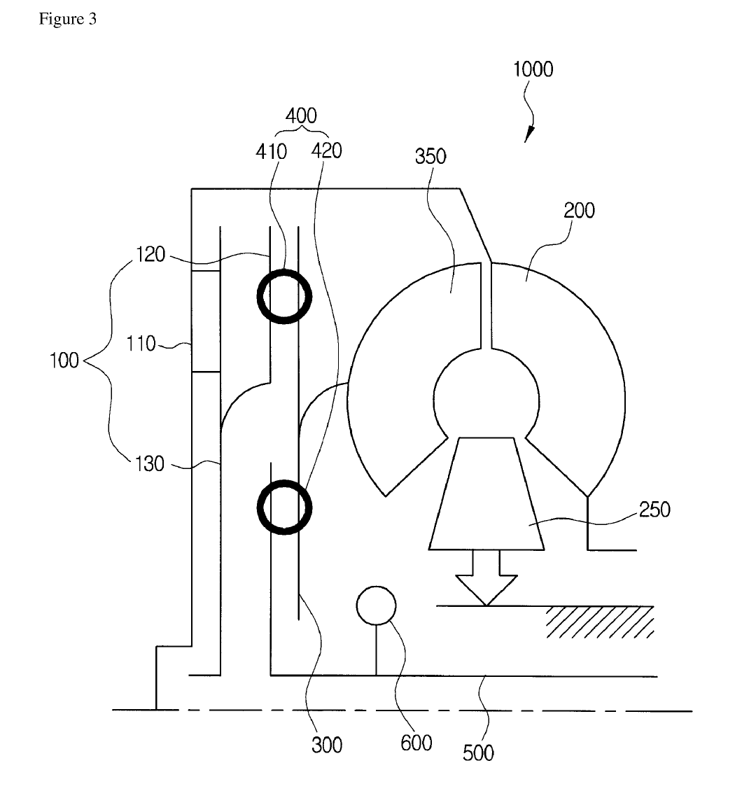

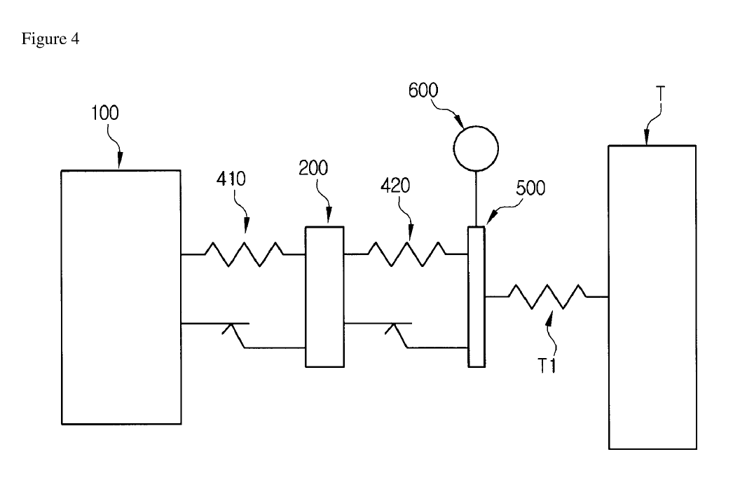

FIG. 3 shows a schematic cross-sectional view of a torque converter for a vehicle (1000) (hereinafter, referred to as ‘torque converter’) including a vibration reduction apparatus using a pendulum according to a first exemplary embodiment of the present invention, and FIG. 4 shows a power transfer view of the torque converter 1000.

Although the present exemplary embodiment illustrates a configuration of a torque converter of a twin damper type, the present invention is not limited thereto, but may also be applied to a series damper according to a second exemplary embodiment or a turbine damper according to a third exemplary embodiment, and may be further applied to a torque converter in which a pendulum damper is mounted on a hub 500 side.

As shown in FIG. 3, the torque converter 1000 is configured to generally include a main member 100, an intermediate member 300, a torsional damper 400, a hub 500, and a vibration reduction apparatus 600.

The main member 100 includes a front cover 110, a lock up clutch 120, a piston 130, and an impeller 200.

In more detail, the torque converter 1000 includes the front cover 110 connected to a crank shaft of an engine to be rotated, the impeller 200 connected to the front cover 110 to be rotated together with the front cover 110, a turbine 350 disposed at a position facing the impeller 200, and a reactor 250 positioned between the impeller 200 and the turbine 350 and changing a flow of oil discharged from the turbine 350 to be transferred to the impeller 200. The reactor 250 transferring the oil to the impeller 200 has the same rotation center as the front cover 110. In addition, the torque converter 1000 provides the lock up clutch 120 as a means for directly connecting the engine and a transmission to each other. The lock up clutch 120 is disposed between the front cover 110 and the turbine 350.

The lock up clutch 120 is formed in approximately a circular plate, and includes the piston 130 which is movable in a shaft direction.

In addition, the lock up clutch 120 includes the torsional damper 400 coupled thereto. The torsional damper 400 serves to transfer driving power transferred through the lock up clutch 120 to the turbine 350 and to absorb torsional force acting in a rotation direction of a shaft and to attenuate vibration.

The torsional damper 400 may include a first torsional damper 410 included between the lock up clutch 120 and the intermediate member 300, and a second torsional damper 420 included between the intermediate member 300 and the hub 500.

The intermediate member 300 is connected to the turbine 350.

In this case, the vibration reduction apparatus 600 is coupled to the hub 500 disposed at a rear end of the second torsional damper 420, thereby making it possible to absorb vibration and impact in a rotation direction. That is, in the case in which the vibration reduction apparatus 600 is coupled to the hub 500 as compared to the case in which the vibration reduction apparatus 600 is coupled to the intermediate member 300, since the vibration reduction apparatus 600 is operated in a state in which the first torsional damper 410 and the second torsional damper 420 absorb the vibration and the impact in the rotation direction to a certain degree, the vibration reduction apparatus 600 may sufficiently attenuate the vibration and the impact in the rotation direction particularly in a low speed revolutions per minute (RPM) region.

In addition, the first torsional damper 410 and the second torsional damper 420 each have a main element and a sub-element, and the main element of the first torsional damper 410 may be the main member 100, and the sub-element thereof may be the intermediate member 300. In addition, the main element of the second torsional damper 420 may be the intermediate member 300, and the sub-element thereof may be the hub 500.

In this case, the main element of the second torsional damper 420 and the sub-element of the first torsional damper 410 may be connected to each other to be non-rotatable with respect to each other. That is, the first torsional damper 410 and the second torsional damper 420 are not objects which are rotated with respect to each other through a damper or another power transfer member between the main element of the second torsional damper 420 and the sub-element of the first torsional damper 410, and may be operated as a single member.

Further, the vibration reduction apparatus 600 may be disposed on the sub-element of the second torsional damper 420, that is, the hub 500.

### Second Embodiment (Series Damper Type)

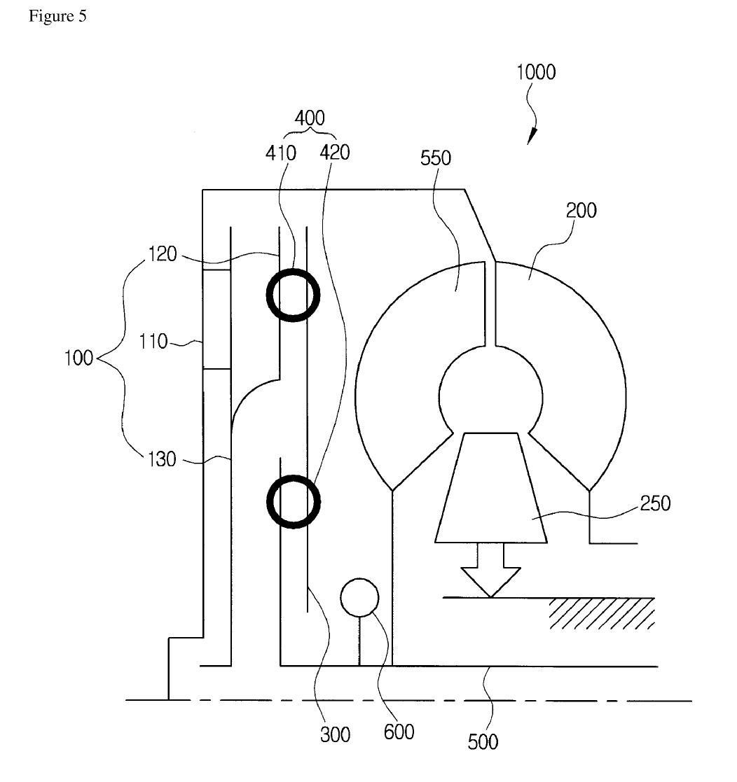

FIG. 5 shows a schematic cross-sectional view of a torque converter for a vehicle (1000) including a vibration reduction apparatus using a pendulum according to a second exemplary embodiment of the present invention.

As shown in FIG. 5, the torque converter 1000 is configured to generally include a main member 100, an intermediate member 300, a torsional damper 400, a hub 500, and a vibration reduction apparatus 600.

The main member 100 includes a front cover 110, a lock up clutch 120, a piston 130, and an impeller 200.

Since the torque converter 1000 according to the second exemplary embodiment of the present invention has a basic configuration similar to that of the torque converter according to the first exemplary embodiment described above, a detailed description of a detail configuration thereof will be omitted, and only a configuration having a difference will be described below in detail.

The torsional damper 400 may include a first torsional damper 410 included between the lock up clutch 120 and the intermediate member 300, and a second torsional damper 420 included between the intermediate member 300 and the hub 500.

The hub 500 is connected to a turbine 550.

In this case, the vibration reduction apparatus 600 is disposed on the hub 500 disposed at a rear end of the second torsional damper 420, thereby reducing vibration and impact generated from the torsional damper 400.

The vibration reduction apparatus 600 is coupled to the hub 500, thereby reducing the vibration and the impact in the rotation direction. That is, in the case in which the vibration reduction apparatus 600 is coupled to the hub 500 as compared to the case in which the vibration reduction apparatus 600 is coupled to the intermediate member 300, since the vibration reduction apparatus 600 is operated in a state in which the first torsional damper 410 and the second torsional damper 420 absorb the vibration and the impact in the rotation direction to a certain degree, the vibration reduction apparatus 600 may sufficiently attenuate the vibration and the impact in the rotation direction particularly in a low speed revolutions per minute (RPM) region.

In addition, the first torsional damper 410 and the second torsional damper 420 each have a main element and a sub-element, and the main element of the first torsional damper 410 may be the main member 100, and the sub-element thereof may be the intermediate member 300. In addition, the main element of the second torsional damper 420 may be the intermediate member 300, and the sub-element thereof may be the hub 500 and the turbine 550.

Further, the vibration reduction apparatus 600 may be disposed on the sub-element of the second torsional damper 420, that is, the hub 500.

### Third Embodiment (Turbine Damper Type)

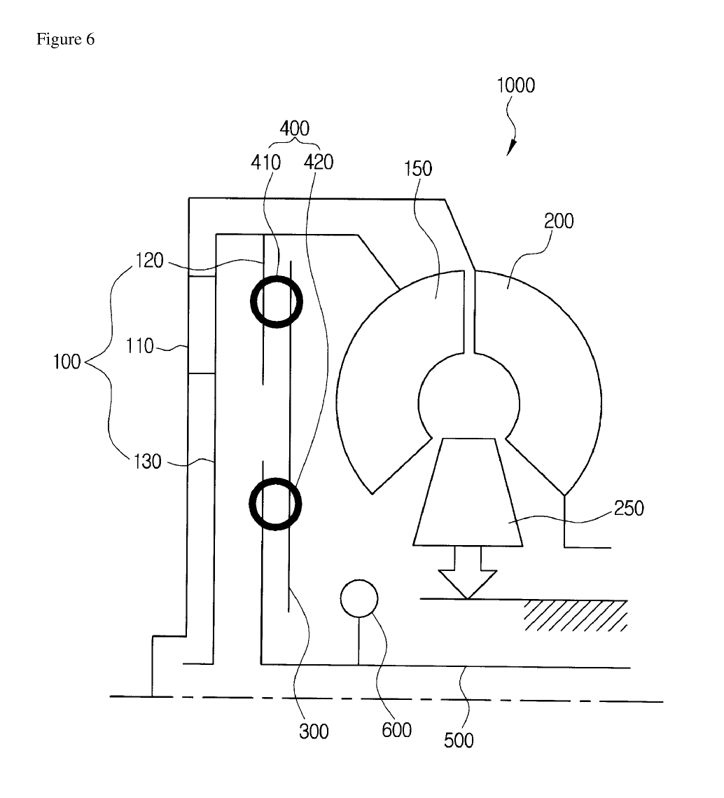

FIG. 6 shows a schematic cross-sectional view of a torque converter for a vehicle (1000) including a vibration reduction apparatus using a pendulum according to a third exemplary embodiment of the present invention.

As shown in FIG. 6, the torque converter 1000 is configured to generally include a main member 100, an intermediate member 300, a torsional damper 400, a hub 500, and a vibration reduction apparatus 600.

The main member 100 includes a front cover 110, a lock up clutch 120, a piston 130, and an impeller 200.

Since the torque converter 1000 according to the third exemplary embodiment of the present invention has a basic configuration similar to that of the torque converter according to the first exemplary embodiment described above, a detailed description of a detail configuration thereof will be omitted, and only a configuration having a difference will be described below in detail.

The torsional damper 400 may include a first torsional damper 410 included between the lock up clutch 120 and the intermediate member 300, and a second torsional damper 420 included between the intermediate member 300 and the hub 500.

The lock up clutch 120 may be connected to a turbine 150.

In this case, the vibration reduction apparatus 600 is disposed on the hub 500 disposed at a rear end of the second torsional damper 420, thereby reducing vibration and impact generated from the torsional damper 400.

The vibration reduction apparatus 600 is coupled to the hub 500, thereby reducing the vibration and the impact in the rotation direction. That is, in the case in which the vibration reduction apparatus 600 is coupled to the hub 500 as compared to the case in which the vibration reduction apparatus 600 is coupled to the intermediate member 300, since the vibration reduction apparatus 600 is operated in a state in which the first torsional damper 410 and the second torsional damper 420 absorb the vibration and the impact in the rotation direction to a certain degree, the vibration reduction apparatus 600 may sufficiently attenuate the vibration and the impact in the rotation direction particularly in a low speed revolutions per minute (RPM) region.

In addition, the first torsional damper 410 and the second torsional damper 420 each have a main element and a sub-element, and the main element of the first torsional damper 410 may be the main member 100 including the turbine 150, and the sub-element thereof may be the intermediate member 300. In addition, the main element of the second torsional damper 420 may be the intermediate member 300, and the sub-element thereof may be the hub 500.

Further, the vibration reduction apparatus 600 may be disposed on the sub-element of the second torsional damper 420, that is, the hub 500.

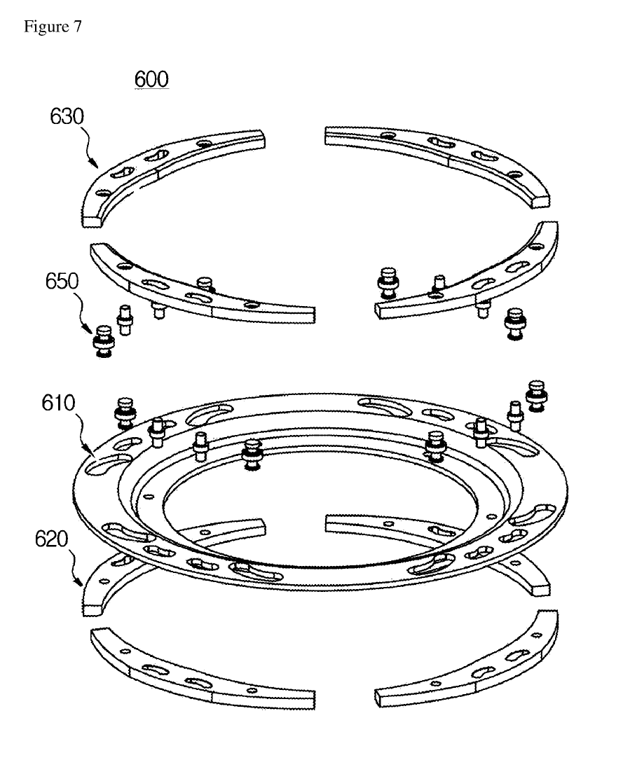

FIG. 7 shows an exploded perspective view of the vibration reduction apparatus 600. The vibration reduction apparatus 600 is configured to include a support plate 610, a plurality of pendulums 620 and 630, and a plurality of coupling pins 650.

The support plate 610 may be coupled to the rear end of the second torsional damper 420 by a rivet. The pendulums 620 and 630 are coupled to the support plate 610 so as to be freely-rotatable as much as a predetermined distance along a circumferential direction of the support plate 610.

The vibration reduction apparatus 600 described above may absorb the vibration and the impact in the rotation direction of the torsional damper 400 using the pendulums 620 and 630 which are moved in a radial direction by centrifugal force.

A technical spirit of the present invention should not be construed to being limited to the above-mentioned exemplary embodiments. The present invention may be applied to various fields and may be variously modified by those skilled in the art without departing from the scope of the present invention claimed in the claims. Therefore, it is obvious to those skilled in the art that these alterations and modifications fall in the scope of the present invention.

### DETAILED DESCRIPTION OF MAIN ELEMENTS

1000: torque converter
100: main member
110: front cover
120: lock up clutch
130: piston
150, 350, 550: turbine
200: impeller
250: reactor
300: intermediate member
400: torsional damper
410: first torsional damper
420: second torsional damper
500: hub
600: vibration reduction apparatus

1. A torque converter for a vehicle including a vibration reduction apparatus using a pendulum, the torque converter comprising:
a front cover;
an impeller coupled to the front cover to be rotated together with the front cover;
a turbine disposed at a position facing the impeller;
a reactor positioned between the impeller and the turbine and changing a flow of oil discharged from the turbine to the impeller side;
a lock up clutch including a piston connecting the front cover and a first torsional damper to each other;
an intermediate member connecting the first torsional damper and a second torsional damper to each other; and a hub connected to the second torsional damper to transfer driving power to a transmission, wherein the vibration reduction apparatus absorbing vibration and impact is coupled to one side of the hub.

2. The torque converter of claim 1, wherein the turbine is coupled to one side of the intermediate member.

3. The torque converter of claim 1, wherein the turbine is coupled to one side of the hub.

4. The torque converter of claim 1, wherein the turbine is coupled to one side of the lock up clutch.

5. The torque converter of claim 1, wherein the vibration reduction apparatus includes:
a support plate;
a plurality of pendulums disposed at one side or both sides of the support plate; and a plurality of coupling pins coupling the pendulums to the support plate while varying positions of the pendulums depending on centrifugal force.
